(19) United States
(12) Patent Application Publication
(10) Pub. No.: US 2010/0257485 A1
(43) Pub. Date: Oct. 7, 2010

(54) OBJECT NETWORK ALIGNMENT LINE

(75) Inventors: Sami E. Ghantous, Malibu, CA (US); Jose Madeira de Freitas Garcia, San Francisco, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: AUTODESK, INC., San Rafael, CA (US)

(21) Appl. No.: 12/416,674

(22) Filed: Apr. 1, 2009

(51) Int. Cl. G06F 3/048

(52) U.S. Cl. 715/849

(57) ABSTRACT

A method, apparatus, article of manufacture, and a computer readable storage medium provide the ability to manipulate a segment of a network in a computer drawing application. A graphics drawing program is displayed on a display device. User input is accept that obtains a drawing having graphics objects. A connected object network object is created. A subset of the graphics objects (that are connected to each other) are added to the connected object network object. User input is accepted that selects a first graphic object in the subset and in response, an alignment line is displayed across all of the graphic objects in the connected object network object. The alignment line graphically indicates that all of the graphic objects in the subset are part of the connected object network object.

### CROSS-REFERENCE TO RELATED APPLICATIONS

This application is related to the following co-pending and commonly-assigned patent application, which application is incorporated by reference herein:

U.S. patent application Ser. No. 11/933,891, entitled “INTERCONNECTED OBJECTS SLOPE MODIFICATION TOOL”, by Sami E. Ghantous, Rebecca F. Richkus, and Thord Backe, Attorney Docket No. 30566.416-US-01, filed on Nov. 1, 2007.

### BACKGROUND OF THE INVENTION

1. Field of the Invention

The present invention relates generally to piping and plumbing computer aided design systems, and in particular, to a method, apparatus, and article of manufacture for utilizing an alignment line to determine objects in a connected network during an editing operation.

2. Description of the Related Art

Computer drafting and computer-aided design (CAD) applications are often used during the design and construction process to assist in designing building solutions. For example, such an application may be utilized to design piping and plumbing systems within a project. When creating three dimensional (3D) models of connected object networks in such a CAD application, the models can become cluttered and confusing because there may be a number of object networks crossing the view path of the modeler. Such clutter and confusion can lead to wasted time being spent in determining and selecting a particular object network during editing of such a network.

FIG. 1 illustrates a display of two object networks that a user is working on in the prior art. Object network 1 102 and object network 2 104 are displayed in the drawing. As illustrated, even with just two networks 102 and 104, discerning between the two different networks can be confusing.

In addition, connected networks of objects (e.g., networks 102 and 104) may have editing capabilities based on moving one object within the connected network. It may be hard to predict the outcome of an edit, because knowledge of all of the objects in the connected network may be unclear.

For example, when an object such as a pipe is selected in the prior art, such an object/pipe could be manipulated. In this regard, various grips may be exposed to the user for corner fitting or modifying the length of the pipe. However, other parts (e.g., parts connected to the object/pipe or part of a network that includes the object/pipe) may or may not move accordingly. The prior art may indicate that an adjacent pipe segment is related to the object/pipe somehow but details regarding such adjacent parts or the ability to modify such adjacent parts or a network that included both the object/pipe and adjacent parts was not available.

Further, to edit a part of a network 102/104 in the prior art, the user was required to carefully select the individual components that the user desired to edit. The ability to view the network 102/104 that an object was part of in an easy understandable manner or to work with the network 102/104 as a whole was not available. Further, the prior art failed to provide the ability to edit a small portion of a network 102/104 while at the same monitoring and viewing the effect of such an edit on the connected network 102/104 as a whole.

In view of the above, what is needed is a mechanism for easily determining the objects in a connected network while also providing editing capabilities to both the constituent parts of a connected network and the connected network as a whole.

### SUMMARY OF THE INVENTION

One or more embodiments of the invention provide an alignment line that visually differentiates a network of connected objects whenever an object in the network is selected. Editing capabilities and features associated with the network are displayed and used based on the alignment line to provide a flexible and easy mechanism to both predict the outcome and perform an edit to the network or a portion of the network.

### BRIEF DESCRIPTION OF THE DRAWINGS

Referring now to the drawings in which like reference numbers represent corresponding parts throughout:

FIG. 1 illustrates a display of two object networks that a user is working on in the prior art;

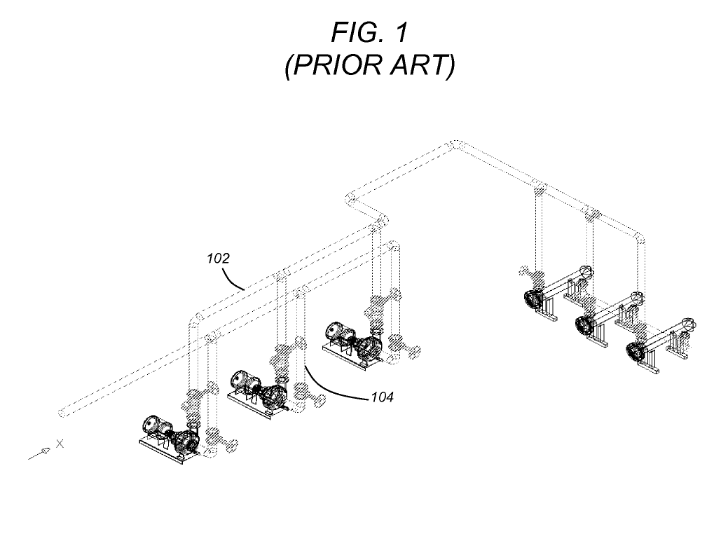

FIG. 2 is an exemplary hardware and software environment used to implement one or more embodiments of the invention;

FIG. 3 illustrates the display of an alignment line that appears across the entire connected network of parts when a particular part is selected in the network in accordance with one or more embodiments of the invention; and

FIG. 4 is a flow chart illustrating the logical flow for manipulating a segment of a network in a computer drawing application in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Hardware Environment

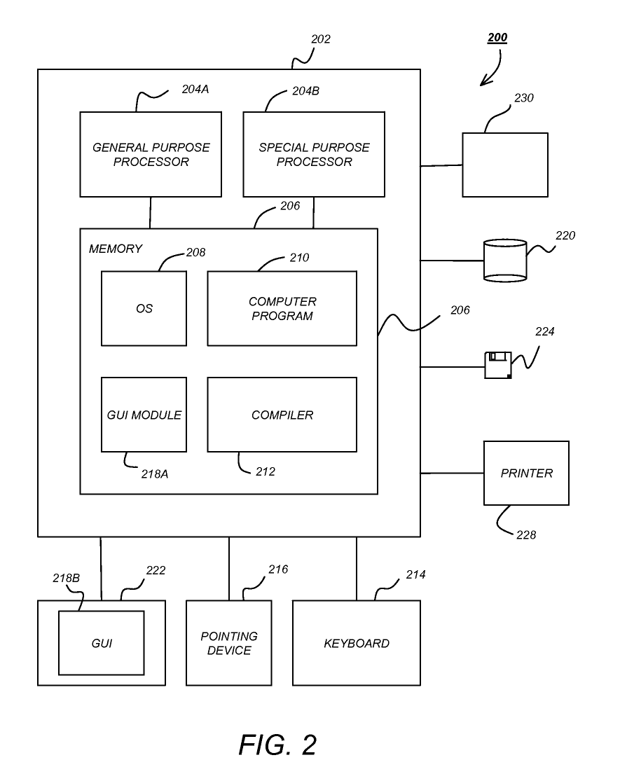

FIG. 2 is an exemplary hardware and software environment 200 used to implement one or more embodiments of the invention. Computer 200 may be a user computer, server computer, or may be a database computer. The computer 202 comprises a general purpose hardware processor 204A and/or a special purpose hardware processor 204B (hereinafter alternatively collectively referred to as processor 204) and a memory 206, such as random access memory (RAM). The computer 202 may be coupled to other devices, including input/output (I/O) devices such as a keyboard 214, a mouse device 216 and a printer 228.

In one embodiment, the computer 202 operates by the general purpose processor 204A performing instructions defined by the computer program 210 under control of an operating system 208. The computer program 210 and/or the operating system 208 may be stored in the memory 206 and may interface with the user and/or other devices to accept input and commands and, based on such input and commands and the instructions defined by the computer program 210 and operating system 208 to provide output and results.

Output/results may be presented on the display 222 or provided to another device for presentation or further processing or action. In one embodiment, the display 222 comprises a liquid crystal display (LCD) having a plurality of separately addressable liquid crystals. Each liquid crystal of the display 222 changes to an opaque or translucent state to form a part of the image on the display in response to the data or information generated by the processor 204 from the application of the instructions of the computer program 210 and/or operating system 208 to the input and commands. The image may be provided through a graphical user interface (GUI) module 218A. Although the GUI module 218A is depicted as a separate module, the instructions performing the GUI functions can be resident or distributed in the operating system 208, the computer program 210, or implemented with special purpose memory and processors.

Some or all of the operations performed by the computer 202 according to the computer program 210 instructions may be implemented in a special purpose processor 204B. In this embodiment, the some or all of the computer program 210 instructions may be implemented via firmware instructions stored in a read only memory (ROM), a programmable read only memory (PROM) or flash memory in within the special purpose processor 204B or in memory 206. The special purpose processor 204B may also be hardwired through circuit design to perform some or all of the operations to implement the present invention. Further, the special purpose processor 204B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 202 may also implement a compiler 212 which allows an application program 210 written in a programming language such as COBOL, Pascal, C++, FORTRAN, or other language to be translated into processor 204 readable code. After completion, the application or computer program 210 accesses and manipulates data accepted from I/O devices and stored in the memory 206 of the computer 202 using the relationships and logic that was generated using the compiler 212.

The computer 202 also optionally comprises an external communication device such as a modem, satellite link, Ethernet card, or other device for accepting input from and providing output to other computers.

In one embodiment, instructions implementing the operating system 208, the computer program 210, and the compiler 212 are tangibly embodied in a computer-readable medium, e.g., data storage device 220, which could include one or more fixed or removable data storage devices, such as a zip drive, floppy disc drive 224, hard drive, CD-ROM drive, tape drive, etc. Further, the operating system 208 and the computer program 210 are comprised of computer program instructions which, when accessed, read and executed by the computer 202, causes the computer 202 to perform the steps necessary to implement and/or use the present invention or to load the program of instructions into a memory, thus creating a special purpose data structure causing the computer to operate as a specially programmed computer executing the method steps described herein. Computer program 210 and/or operating instructions may also be tangibly embodied in memory 206 and/or data communications devices 230, thereby making a computer program product or article of manufacture according to the invention. As such, the terms “article of manufacture,” “program storage device” and “computer program product” as used herein are intended to encompass a computer program accessible from any computer readable device or media.

Of course, those skilled in the art will recognize that any combination of the above components, or any number of different components, peripherals, and other devices, may be used with the computer 202.

Although the term “user computer” is referred to herein, it is understood that a user computer 202 may include portable devices such as cellphones, notebook computers, pocket computers, or any other device with suitable processing, communication, and input/output capability.

### Software Environment

The computer program 210 may consist of a software application such as a computer-aided design (CAD) application, a computer drawing program, a two-dimensional (2D) or three-dimensional (3D) modeling application, or a building systems application that is executing on computer 202. As used herein, the software application 210 will be referred to as the building systems application (BSA) 210. Such a BSA 210 may be a two-dimensional (2D) or three-dimensional (3D) application used for designing plumbing systems or other systems. As used herein, embodiments of the invention are not intended to be limited to plumbing/piping applications but may be used in any type of system where a property is applied to a selected run/length based on user-defined attributes. For example, embodiments may be utilized in a plumbing system, sprinkler system, air conditioning system, any piping system, rain gutter, tunnel, scaffolding, road, embankment, grading, hillside, etc. Similarly, embodiments may be used to define, model, or simulate sedimentary deposits along a shoreline (e.g., that decrease based on distance from a source), river, aqueduct, or lava flow, etc.

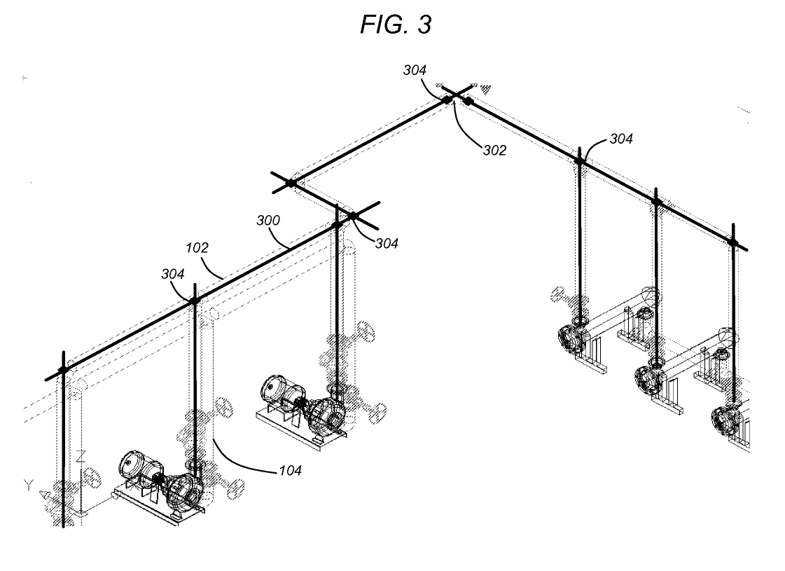

As described above, the problem with the prior art lies in the confusion with respect to the selection of a desired network 102/104. One or more embodiments of the invention provide for the use of an alignment line to more easily discern between cluttered/confusing networks. Upon selecting an object within a network, the alignment line appears across the entire network of connected objects. FIG. 3 illustrates the display of an alignment line 300 that appears across the entire connected network 102 of parts when a particular part 302 is selected in the network.

The alignment line 300 is an artifact of the objects 302 (and other objects/parts in the network) and may not be a separate function or feature of the program. Whenever a user selects an object 302, its alignment line 300, along with the alignment line 300 of any objects connected to it will display. The display of the alignment line 300 is provided dynamically as a real-time visual aid and provides the user with flexibility to work and edit the model including the network via the alignment line 300 itself and/or the object selected 302. In this regard, the user is not locked out of or prevented from performing other functions when the alignment line is displayed. Further, since the alignment line 300 is displayed upon the selection of an object 302, a separate function and/or additional steps for selecting the entire network or displaying the entire network is not necessary nor required. Further, functionality to edit the network 102/104 or a portion of the network are provided via the alignment line 300 and graphical user interfaces (e.g., grips) associated with the alignment line.

### Logical Flow

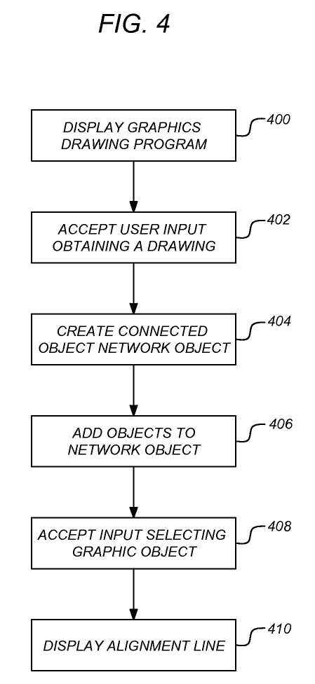

FIG. 4 is a flow chart illustrating the logical flow for manipulating a segment of a network in a computer drawing application in accordance with one or more embodiments of the invention.

At step 400, a graphics drawing program is displayed (using a computer processor) on a display device.

At step 402, user input is accepted (using the computer processor) that obtains a drawing in the graphics drawing program. The drawing has one or more graphics objects.

At step 404, a connected object network object is created. As used herein, the network object is a separate object instance within the drawing program and represents a set of connected objects. This step creates an empty connected object network object (i.e., there are no objects yet in the connected object network object yet). Such an object may be an object-oriented object representing the connected object network in the graphics drawing program. Thus, the connected object network object becomes an instantiated object.

At step 406, a subset of the graphics objects are added (using the computer processor) to the connected object network object. All of the graphics objects in the connected object are connected to each other. Such a connection to each other may be realized by all of the connected graphics objects being part of a common subsystem (e.g., heating, ventilation, air conditioning, cold water, hot water, plumbing, electrical, cabling, etc.). Further, each object in the connected object network object is “connected” to the other objects via the other objects in the system. As illustrated in FIG. 3, each piping segment is connected to the other piping segments via intermediary pipes, joints, valves, etc. In other words, each object (e.g., pipe, joint, valve, etc.) in a connected object network object is related to each of the other graphics objects in the connected object network object by virtue of the network/system in which the objects are part of.

At step 408, user input is accepted (using the computer processor) to select a first graphic object 302 of the graphic objects in the subset (i.e., of the objects/parts in the connected object network object).

At step 410, in response to the selecting of the first graphic object, an alignment line 300 is displayed (using the computer processor) across all of the graphic objects in the connected object network object. The alignment line 300 graphically indicates that all of the graphic objects in the subset are part of the connected object network object. For example, the alignment line 300 may be a physically displayed geometric line that connects all of the one or more graphic objects in the connected object network object. Such a geometric line may be displayed in a color (e.g., red) that differentiates the alignment line 300 from the one or more graphic objects in the network 102/104. Thus, the alignment line 300 serves to distinguish/identify the network 102/204 separately from the parts that constitute that network 102/104 (e.g., a dashed line, solid line, bold line, multiple colored line, highlighted outline of parts in the network, etc.).

To assist in a manipulation of the network 102/104, embodiments of the invention may provide for the use of a glyph or a grip. A glyph is a symbol that conveys information non-verbally. A grip is a glyph that has a defined position and an active area within which a pointing device will “snap” to that position. To manipulate the system, a user selects the grip or glyph and drags the cursor in a desired direction. The underlying graphical object is then manipulated based on the grip limitations and the drag operation. Accordingly, step 410 may also include the display of one or more grips on or proximate to the alignment line. Such grips are for the alignment line 300 and allow a modification of the connected object network object. User input is then accepted via the grips to modify the connected object network. FIG. 3 illustrates the use of grips 304 that allow the user to manipulate the network object itself.

Such a modification of the network object using the grips may modify a portion of the connected object network object 102 independently from the entire/rest of the connected object network object 102. In other words small portions of the connected object network object 102 can be edited/modified without affecting the remainder of the network 102. Further, when modifying a portion of the network 102, those objects that are directly related to the modified part may be automatically adjusted/modified as part of the modification. In other words, if a piping segment is modified, the joints attached to such a piping segment may be modified but other piping segments may not be modified since they are not directly related/connected to the part of the network being modified. Similarly, a portion of the network 102 could be modified by adjusting the location of a segment (e.g., adjusting the height of a subset of parts in a piping segment) where the remainder of the network remains at the same location (e.g., the joints would be adjusted to accommodate the new height). Thus, parts/objects directly connected to and/or adjacent to a modified part/object may be modified but remaining parts in the network 102

In addition to the above, the graphic objects (e.g., the pipes, joints, valves, etc.) that make up the connected object network 102/104 may be driven geometrically by the network 102/104. For example, the direction/flow of the network 102/104 may determine the geometric direction of a pipe/joint or other part of the network 102/104. Further, if the network or a portion of the network is moved, the underlying part that is part of the network may be modified accordingly. For example, if a grip of the alignment line (e.g., grip 304) is used to extend the length of one portion of the alignment line 300, the underlying piping segment may be expanded or adjusted to accommodate the new location. Thus, the joint may be moved and the directly related/connected piping segment is also modified to accommodate the new location.

Further, the network object 102/104 may respond to rules of the network and the space in which it is being developed. For example, if the network relates to a hot water piping network, rules of the network may not allow its placement adjacent to flammable materials or electrical conduit. With such a rule, adjustments to the network would not permit movement that places parts of the network adjacent to flammable materials or electrical conduit. In another example, a piping system network may not allow a slope greater than a certain range. In such an example, any modification to the network would be constrained to a particular slope.

Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

In summary, embodiments of the invention provide the ability to display an alignment line that differentiates and provides the ability to adjust and modify a network from parts that constitute the network in a computer drawing application. Further, the alignment line is displayed dynamically upon the selection of a constituent part of the network (that the alignment line represents) and provides real-time feedback and editing capabilities to a user.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for manipulating a segment of a network in a computer drawing application, comprising:
(a) displaying, using a computer processor, a graphics drawing program on a display device;
(b) accepting, using the computer processor, user input obtaining a drawing in the graphics drawing program, wherein the drawing comprises one or more graphics objects;
(c) creating, using the computer processor, a connected object network object;
(d) adding, using the computer processor, a subset of the one or more graphics objects to the connected object network object, wherein all of the one or more graphics objects in the connected object network object are connected to each other;
(e) accepting, using the computer processor, user input selecting a first graphic object of the one or more graphic objects in the subset; and
(f) in response to the selecting of the first graphic object, displaying, using the computer processor, an alignment line across all of the graphic objects in the connected object network object, wherein the alignment line graphically indicates that all of the graphic objects in the subset are part of the connected object network object.

2. The method of claim 1, further comprising:
displaying, using the computer processor, one or more grips on the alignment line; and
accepting user input, via the one or more grips using the computer processor, wherein the user input modifies the connected object network object.

3. The method of claim 2, wherein the modifying modifies a portion of the connected object network object independently from the entire connected object network object.

4. The method of claim 1, wherein each of the one or more graphic objects in the connected object network object are driven geometrically by the connected object network object.

5. The method of claim 1, wherein the alignment line comprises a geometric line that connects all of the one or more graphic objects in the connected object network object.

6. The method of claim 1, wherein the alignment line comprises a geometric line in a color that differentiates the alignment line from the one or more graphic objects.

7. An apparatus for manipulating a segment of a network in a system in a computer drawing application comprising:
(a) a computer having a memory;
(b) a computer drawing application executing on the computer, wherein the computer drawing application is configured to
(i) display a graphics drawing program on a display device;
(ii) accept user input obtaining a drawing in the graphics drawing program, wherein the drawing comprises one or more graphics objects;
(iii) create a connected object network object;
(iv) add a subset of the one or more graphics objects to the connected object network object, wherein all of the one or more graphics objects in the connected object network object are connected to each other;
(v) accept user input selecting a first graphic object of the one or more graphic objects in the subset; and
(vi) in response to the user input selecting the first graphic object, display an alignment line across all of the graphic objects in the connected object network object, wherein the alignment line graphically indicates that all of the graphic objects in the subset are part of the connected object network object.

8. The apparatus of claim 7, wherein the computer drawing application is further configured to:
display one or more grips on the alignment line; and
accept user input, via the one or more grips, wherein the user input modifies the connected object network object.

9. The apparatus of claim 8, wherein the user input modifies a portion of the connected object network object independently from the entire connected object network object.

10. The apparatus of claim 7, wherein each of the one or more graphic objects in the connected object network object are driven geometrically by the connected object network object.

11. The apparatus of claim 7, wherein the alignment line comprises a geometric line that connects all of the one or more graphic objects in the connected object network object.

12. The apparatus of claim 7, wherein the alignment line comprises a geometric line in a color that differentiates the alignment line from the one or more graphic objects.

13. A computer readable storage medium encoded with computer program instructions which when accessed by a computer cause the computer to load the program instructions to a memory therein creating a special purpose data structure causing the computer to operate as a specially programmed computer, executing a method of manipulating a segment of a network in a computer drawing application, comprising:
(a) displaying, in the specially programmed computer, a graphics drawing program on a display device;
(b) accepting, in the specially programmed computer, user input obtaining a drawing in the graphics drawing program, wherein the drawing comprises one or more graphics objects;
(c) creating, in the specially programmed computer, a connected object network object;
(d) adding, in the specially programmed computer, a subset of the one or more graphics objects to the connected object network object, wherein all of the one or more graphics objects in the connected object network object are connected to each other;
(e) accepting, in the specially programmed computer, user input selecting a first graphic object of the one or more graphic objects in the subset; and
(f) in response to the selecting of the first graphic object, displaying, in the specially programmed computer, an alignment line across all of the graphic objects in the connected object network object, wherein the alignment line graphically indicates that all of the graphic objects in the subset are part of the connected object network object.

14. The computer readable storage medium of claim 13, further comprising:
displaying, in the specially programmed computer, one or more grips on the alignment line; and
accepting user input, via the one or more grips in the specially programmed computer, wherein the user input modifies the connected object network object.

15. The computer readable storage medium of claim 14, wherein the modifying modifies a portion of the connected object network object independently from the entire connected object network object.

16. The computer readable storage medium of claim 13, wherein each of the one or more graphic objects in the connected object network object are driven geometrically by the connected object network object.

17. The computer readable storage medium of claim 13, wherein the alignment line comprises a geometric line that connects all of the one or more graphic objects in the connected object network object.

18. The computer readable storage medium of claim 13, wherein the alignment line comprises a geometric line in a color that differentiates the alignment line from the one or more graphic objects.
